(19) United States
(12) Patent Application Publication
(10) Pub. No.: US 2005/0184200 A1
(43) Pub. Date: Aug. 25, 2005

(54) Lordosis support

(76) Inventor: Jorg Schwarzbich, Bielefeld (DE)

Correspondence Address: RICHARD M. GOLDBERG, 25 EAST SALEM SREEET, SUITE 419, HACKENSACK, NJ, 07601, US

(21) Appl. No.: 11/057,648

(22) Filed: Feb. 14, 2005

(30) Foreign Application Priority Data
Feb. 19, 2004 (DE) 20 2004 002 569.8

(51) Int. Cl. F16L 5/00

(52) U.S. Cl. 248/56

(57) ABSTRACT

A lordosis support includes a plate that is adapted to be curved, and an adjusting mechanism for adjusting the curvature of the plate wherein the plate is elastically biased into a curved position and the adjusting mechanism is adapted to reduce the curvature of the plate.

The invention relates to a lordosis support comprising a plate that is adapted to be curved, and an adjusting mechanism for adjusting the curvature of the plate.

Lordosis supports are frequently incorporated in back rests of automotive vehicle seats, in particular of driver's seats, and have the purpose to better adapt the contour of the back rest to the anatomy of the driver, so that the spinal column of the driver is optimally supported, in particular in the lumbar vertebra region. The more the plate is curved, the more pronounced is the support in the lumbar vertebra region.

In a known lordosis support of the type indicated above, as it is described for example in EP-A-0 485 483, the curvature-adjustable plate, which is made of plastic, has its upper and lower edges fixed to flexible horizontal wires of a wire grid, which is elastically suspended in a frame of the back rest. The adjusting mechanism is formed by a Bowden cable that is actuated by means of a tension buckle and with which the upper and lower edges of the plate can be drawn together, so that the plate is bent to a larger degree. This construction has the drawback that the actuating force that has to be generated by means of the tension buckle has a non-linear characteristic. When the plate is already bent relatively strongly, it behaves comparatively flexible, so that only a comparatively small force is needed for further drawing together the upper and lower edges. When, in contrast, the plate is adjusted to a minimal curvature, a substantially larger force is required for increasing the curvature. This is a particular disadvantage when the tension buckle is not actuated by hand, but by means of a motor, since, then, the motor must be dimensioned for a correspondingly larger force.

Another drawback of the known construction is that the plate behaves relatively rigid, once it has been fixed in a certain curvature position by means of the Bowden cable. Therefore, when the driver presses against the plate with his back, the plate can hardly yield, and, as a consequence, the driver feels a correspondingly high pressure in his back, which is found uncomfortable during a longer ride.

When the back rest is tilted back and a very high pressure is exerted onto the curved lordosis support, for example, when the vehicle is loaded. the resulting forces that are transmitted onto the adjusting mechanism may become so large that they cause a rupture of tension cables or similar damage.

It is an object of the invention to create a lordosis support which provides a higher seat comfort.

According to the invention, this object is achieved by the feature that the plate is elastically biased into a curved position, and the adjusting mechanism is adapted to reduce the curvature of the plate.

Thus, in the lordosis support according to the invention, the force that is exerted onto the curved plate by the back of the user and the force of the adjusting mechanism act in the same direction, namely in the direction for reducing the curvature. As a result, the plate may yield elastically when it receives a larger load from the back of the user. In this way, a higher seat comfort is achieved.

Useful details and further embodiments of the invention are indicated in the dependent claims.

In a preferred embodiment, the adjusting mechanism is arranged such that it draws the upper and lower edges of the plate apart in opposite directions, against the elastic bias. The elastic bias of the plate into the maximally curved position may then for example be achieved by means of one or more tension springs that are anchored at the upper and lower edges of the plate, so that they have the tendency to draw the upper and lower edges together. Then, the force of the adjusting mechanism only needs to be so large that it overcomes the tension of the springs.

When the plate is formed by a plastic plate which has an intrinsic elasticity and assumes a largely stretched position with little curvature in the non-loaded state, without the force of the springs, the intrinsic elasticity of the plate acts in the sense of assisting the adjusting mechanism. When the plate has a relatively large curvature in its initial state, and the curvature is to be reduced by means of the adjusting mechanism, the tension springs are only expanded to a small degree, and the adjusting mechanism only needs to overcome the tension force of the springs which is then relatively small. When the plate approaches its stretched position, the tension springs are expanded to a larger degree, but an increasingly larger portion of the force of the tension springs is compensated due to the fact that the compressive strain on the plate increases and the bending strain decreases. Thus, in total, the force that has to be applied by means of the adjusting mechanism is relatively small and approximately constant over the whole adjustment range.

In another embodiment, it is also possible to configure the plate such that it has already a certain curvature in the non-loaded state. In this case, the tension springs may be designed to be weaker, accordingly. An approximately constant force characteristic may then be achieved by appropriately setting the force of the tension springs and the intrinsic elasticity of the plate.

In another embodiment, it is also possible that the plate is pre-curved to such an extent that it already assumes the maximal curvature in the non-loaded state. In this embodiment, tension springs can be dispensed with completely.

The pre-curvature of the plate can be achieved by giving an appropriate shake to the plate itself or by means of curved leaf springs inserted or molded into the plate.

Instead of drawing the upper and lower edges of the plate apart by means of the adjusting mechanism, it is also possible, in another embodiment, to have the adjusting mechanism act upon the apex of curvature of the plate with an actuating force that is oriented essentially orthogonal to the plane of the plate. In this embodiment, the strain exerted by the actuating mechanism onto the plate is predominantly a bending strain rather than a tension strain or compressive strain, so that the maximum of the required actuating force is relatively small.

In all described embodiments, especially when the adjusting mechanism is hand-operated, there is the additional advantage that the user can assist the adjusting operation towards smaller curvature by exerting a pressure onto the curved plate with his back.

When the adjusting mechanism is configured such that it draws the upper and lower edges of the plate apart, one of the two edges of the plate may be held stationary, whereas the adjusting mechanism acts only upon the other edge. As an alternative, however, it is also possible that the adjusting mechanism acts on both, the upper and lower edges of the plate. In this way, it may be achieved that the apex of the curvature remains always at the same height while the curvature is adjusted. Optionally, the adjusting mechanism may be configured such that the upper and lower edges of the plate may be adjusted upwardly and downwardly independently from one another. Then, the height of the plate in the back rest and hence the height of the apex of curvature may be adapted as required.

For the embodiment, in which the upper and lower edges of the plate are drawn together by means of a helical spring, a further development of the invention provides a special adjusting mechanism which has a very compact construction and makes is possible to directly adjust the tension force of the helical spring. This adjusting mechanism comprises a screw or spindle which has a helical groove and is axially screwed into the helical spring, so that the wire of the spring will be accommodated in the groove. However, the pitch of the groove in the spindle is different from the pitch of the helical spring in the non-loaded state. When the pitch of the groove is larger than that of the helical spring, the spring is stretched when the spindle is screwed-in. The further the spindle is screwed into the spring, the larger is the stretched portion of the spring, and the longer is the spring in the non-loaded state, so that, accordingly, the force of the spring is smaller when it acts as a tension spring. Conservely, when the pitch of the groove of the spindle is smaller than the pitch of the helical spring, the spring is contracted, and the force of the spring, when used as a tension spring, is reduced, when the spindle is screwed-out.

Thus, with this adjusting mechanism, the adjusting operation is performed by screwing the spindle in or out, i.e. essentially by rotating the spindle. In case of a motor-driven adjusting mechanism, this offers the advantageous possibility to use a motor with high rotary speed and without reduction gear for rotating the spindle. The reduction is then achieved directly by the screw-engagement of the spindle and the spring.

This mechanism for adjusting the force or the natural length of a helical spring, as proposed in accordance with the further development of the invention, may advantageously be utilized independently of the case of application that has been considered here, wherever the characteristic of a helical spring is to be varied by means of an adjusting mechanism.

Embodiment examples of the invention will now be explained in conjunction with the drawings, wherein:

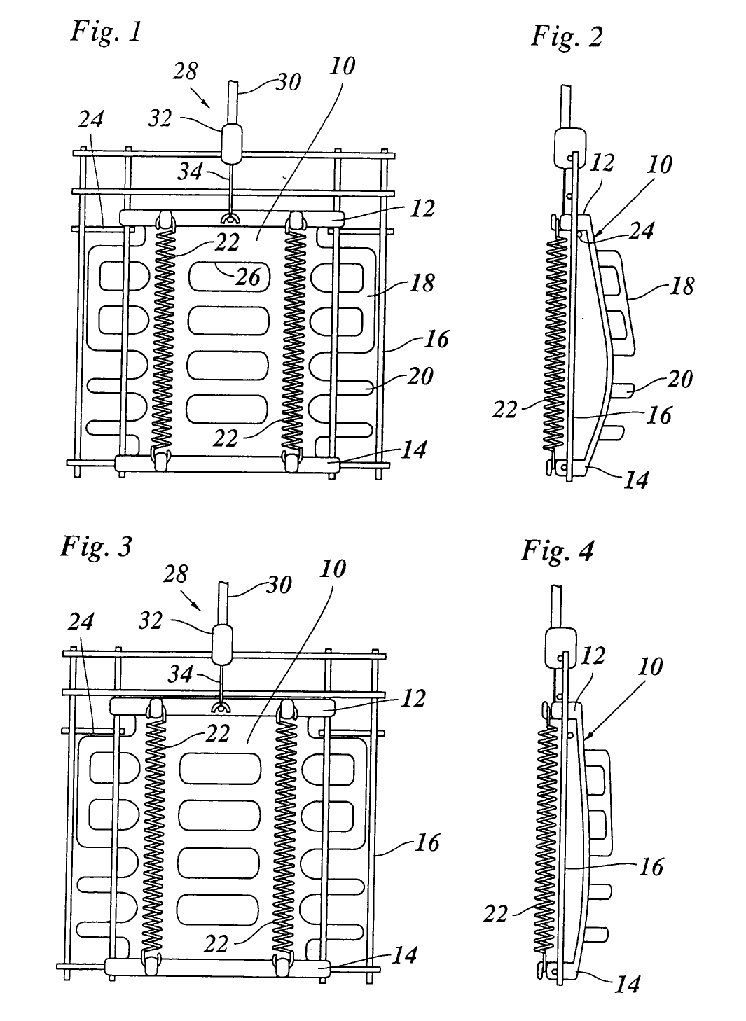

FIG. 1 is a rear view of a lordosis support;

FIG. 2 shows the lordosis support of FIG. 1 in a side view;

FIGS. 3 and 4 are views of the lordosis support corresponding to FIGS. 1 and 2 for a different adjusting position;

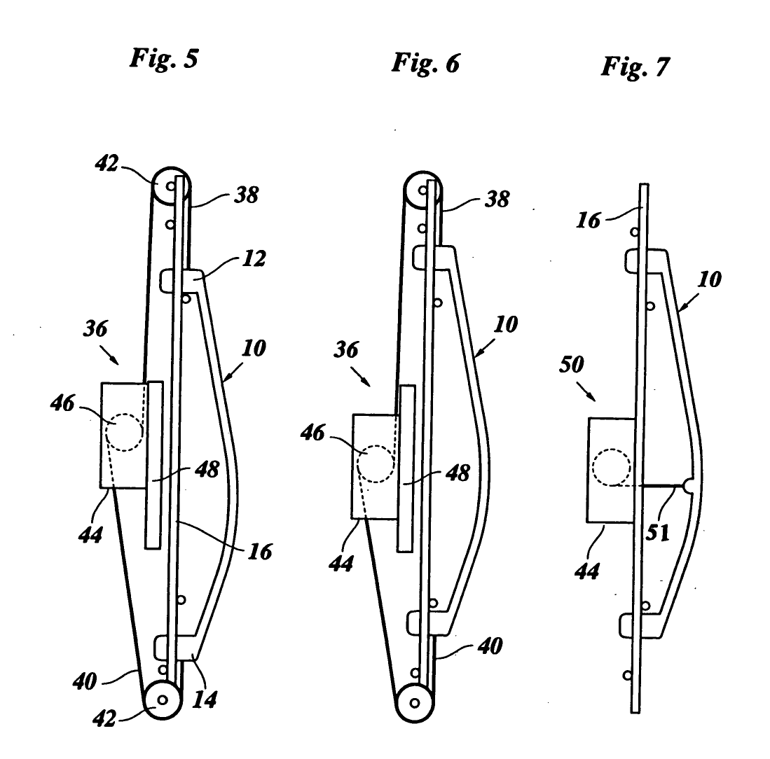

FIGS. 5 and 6 are side views of a lordosis support according to another embodiment in different positions;

FIG. 7 is a side view of a lordosis support according to another embodiment; and

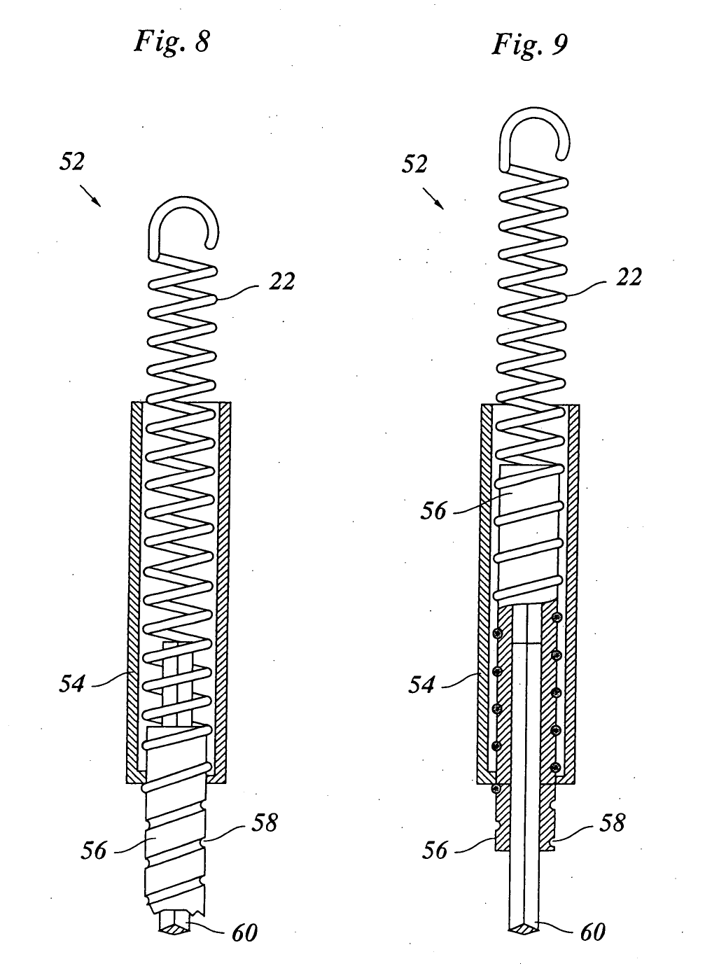

FIGS. 8 and 9 are sectional views of a mechanism for varying the characteristic of a helical spring.

The lordosis support shown in FIG. 1 comprises a curvature-adjustable plate 10 that is formed by an injection-molded plastic member and is held at a wire-grid 16 with thickened upper and lower edges 12, 14. In a manner known per-se, the wire grid 16 is suspended in a frame, which has not been shown, of a back rest of an automotive vehicle seat, so that the plate 10 is facing the back of the user. As is shown in FIG. 2, the plate is slightly curved forwardly in its intermediate portion, so as to suitably support the lumbar vertebra region of the user. The plate 10 has lateral projections 18, 20 which are slightly bent forwardly, as is shown in FIG. 2, so that the plate, as a whole, has a basket-like structure adapted to the anatomy of the back of the user.

The lower edge 14 of the plate 10 is stationarily held at the wire grid 10, for example by snap-fastening, whereas, in the example shown, the upper edge 12 is guided on two vertical bars of the grid so as to slide within a limited range. Two helical springs 22, which act as tension springs and draw the upper and lower edges of the plate 10 together, are anchored at the thickened upper and lower edges 12, 14 of the plate 10 on the side of the wire grid 16. This brings about the curvature of the plate 10 that can be seen in FIG. 2. In FIG. 2, the maximum curvature has been reached, because the upper edge abuts at horizontal bars 24 of the wire grid. The thickened upper and lower edges 12, 14 of the plate, which project towards the rear side, have a certain lever action by which the initial curvature of the plate 10 is facilitated. The flexibility and the bending behaviour of the plate 10 are suitably controlled by cut-outs 26 and reinforcement ribs which have not been shown.

An adjusting mechanism 28 for adjusting the curvature of the plate 10 is formed by a Bowden cable, an outer sleeve 30 of which is supported at the wire grid 10 via a support 32, and the inner wire 34 of which is centrally hooked-in at the upper edge 12 of the plate 10. The other end of the Bowden cable is connected to a hand or motor driven tension buckle which has not been shown.

When the tension buckle is actuated, the inner wire 34 of the bowden cable is drawn-in, and the upper edge 12 of the plate 10, which is movably guided, is drawn upwards, i.e. away from the edge 14, against the force of the tension spring 22. Since, in this way, the plate 10 is stretched, its curvature is reduced, as is shown in FIGS. 3 and 4. When the adjusting mechanism 28 is adjusted in opposite direction, the inner wire 34 yields, and the helical springs 22 contract the plate 10, so that the curvature of the latter increases, as far as the inner wire 34 of the bowden cable permits. When the user presses with his back against the curved plate 10, the plate 10 may elastically yield against the force of the helical springs 22. The tension on the inner wire 34 is thereby relived.

Since, in the embodiment described above, only the upper edge 12 of the plate is movable, an adjustment of the curvature of the plate 10 entrains also a slight change in height of the apex of the curvature. FIGS. 5 and 6 show an embodiment, in which such a change in height of the apex of curvature is avoided and, moreover, the height of the apex of curvature as well as the height of the plate 10 as a whole may be adjusted in accordance with the individual needs of the user.

In this embodiment, both the upper edge 12 and the lower edge 14 of the plate 10 are guided to be displaceable along vertical bars of the wire grid 16. Here, the adjusting mechanism 36 is formed by tension ropes 38 and 40 which are connected to the upper edge 12 and the lower edge 14, respectively, of the plate 10 and are guided over deflection rollers 42 to a winch 44. When a drum 46 of the winch is rotated clock-wise in FIG. 5, both tension ropes 38, 40 are wound onto the drum and are thereby shortened, so that the upper and lower edges of the plate 10 are drawn apart. Since the upper and lower edges move in opposite directions, the apex of curvature of the plate 10 remains essentially stationary.

Moreover, in this embodiment, the winch 44 is guided to be height-adjustable along a guide 48. When the winch 44 is displaced downward, as is shown in FIG. 6, without rotating the drum 46, the plate 10 is shifted upwards, accordingly, as a whole. This permits to adjust the height of the apex of curvature.

FIG. 7 shows another embodiment, in which the adjusting mechanism 50 is also formed by a winch 44. In this case, however, the tension rope 42 acts upon the apex of curvature of the plate 10, so that the tension rope directly exerts a bending strain onto the plate. In this embodiment, the plate 10 is pre-tensioned such that it is held in its maximally curved position solely by its own elasticity. Springs which would draw together the upper and lower edges are therefore not required in this case.

FIG. 8 shows an adjusting mechanism 52 which may be utilized for example in conjunction with a lordosis support similar to the one shown in FIG. 1, for adjusting the tension of the helical spring 22. By way of example, it shall be assumed that the upper and lower edges of the plate 10 are in this case drawn together only by means of a single helical spring 22. The upper end of the spring is to be hooked-in at the upper edge of the plate 10, as in FIG. 1. However, the lower end of the helical spring is fixed at a lower end of a sleeve 54 which surrounds the lower portion of the spring with little play and is itself to be fixed at the lower edge 14 of the plate 10. A spindle 56 plunges into the lower end of the sleeve 54 and has a helical groove 58 in its outer peripheral surface. The depth of the groove 58 is such that it can safely accommodate the spring wire of the helical spring 22, and the spindle 56 is screwed into the helical spring 22, so that the spring wire is accommodated in the groove 58. The pitch of the groove 58 is somewhat larger than the pitch of the helical spring 22 in the non-loaded state. For this reason, the helical spring 22 is slightly stretched in its lower portion into which the spindle 56 is screwed-in.

The spindle 56 is guided to be axially displaceable on a four cornered shaft 60 connected to a rotary drive that has not been shown.

When the four cornered shaft 60 is driven, the spindle 56 is rotated, so that it is screwed deeper into the helical spring 22, as is shown in FIG. 9. As a result, the expanded portion of the helical spring 22 increases, so that the total length of the helical spring is increased accordingly. The rotary drive for the four cornered shaft 60 has to overcome the force that is necessary for expanding the lower end of the helical spring. Thus, this adjusting mechanism 52 also acts against the force of the helical spring 22 and permits to reduce the curvature of the plate 10. The sleeve 54 prevents the helical spring from escaping from the groove 58 of the spindle.

In FIGS. 8 and 9, the helical spring 22 has always been shown in the non-loaded state, so that the natural lengths of the spring can be compared. When mounted in the lordosis support, the helical spring 22 is generally tensioned, so that its pitch is larger than in the non-loaded state. The pitch of the groove 58 of the spindle should be at least as large as the pitch of the helical spring 22 in the state in which the curvature of the plate 10 is at minimum. In this condition, the helical spring 22 may be in screw-engagement with the spindle 56 over its whole length, so that the spring is fixed on its entire length and the plate 10 is held rigidly. However, it is possible and generally convenient that the helical spring 22 still has a flexible portion which is not in engagement with the spindle, even when the curvature of the plate 10 is as small as possible.

The fact that the flexible portion of the helical spring 22, which portion produces the spring action, becomes smaller, when the spindle 56 is screwed-in further and the plate 10 is stretched, has the desirable side-effect that the helical spring 22 becomes stiffer when the curvature of the plate 10 decreases. When the plate 10 is bent forwardly to a large extent, the spring behaves soft, because practically the total length of the spring contributes to the spring action, so that the plate 10 may easily yield to the pressure exerted by the back of the user. When, on the other hand, the plate is curved to a smaller degree, the spring behaves more rigid, so that the plate is less compliant to the pressure of the back. Thus, the user may choose between adjustment positions in which, on the one hand, the plate has only a small curvature but is relatively rigid, and a position in which the plate has a larger curvature but is more compliant.

In general, it should be observed that the function principle of the adjusting mechanism shown in FIGS. 8 and 9 can be employed not only for tension springs but also for compression springs. Moreover, the pitch of the spindle may also be smaller than the pitch of the helical spring, so that the spring becomes shorter when the spindle is screwed-in deeper. Depending on the depth, to which the spindle is screwed-in, one and the same helical spring may in some cases act as a tension spring and in other cases as a compression spring.

1. A lordosis support comprising:
a plate that is adapted to be curved, the plate being elastically biased into a curved configuration, and
an adjusting mechanism for adjusting the curvature of the plate, the adjusting mechanism being adapted to reduce the curvature of the plate.

2. The lordosis support of claim 1, further comprising at least one tension spring, which draws upper and lower edges of the plate together, for elastically biasing the plate.

3. The lordosis support of claim 1, wherein the plate is pre-curved such that it assumes a curved configuration when it is not subject to external forces.

4. The lordosis support of claim 3, wherein the plate is biased into a maximally curved position thereof solely by its own elasticity.

5. The lordosis support according to claim 1, wherein the adjusting mechanism engages at least one of upper and lower edges of the plate for drawing the plate into a stretched position.

6. The lordosis support according to claim 1, wherein the adjusting mechanism engages an apex of curvature of the plate and exerts a force in a direction essentially normal to a plane of the plate for reducing the curvature of the plate.

7. The lordosis support of claim 2, wherein the at least one tension spring includes a helical spring and the adjusting mechanism comprises a spindle that is adapted to be screwed into the helical spring and has a pitch that is different from that of the helical spring.
